(19) United States
(12) Patent Application Publication
(10) Pub. No.: US 2006/0227871 A1
(43) Pub. Date: Oct. 12, 2006

(54) Video thumbnail method

(76) Inventor: Madhukar Budagavi, Dallas, TX (US)

Correspondence Address: TEXAS INSTRUMENTS INCORPORATED, P O BOX 655474, M/S 3999, DALLAS, TX, 75265, US

(21) Appl. No.: 11/095,286

(22) Filed: Mar. 31, 2005

(51) Int. Cl. H04N 7/12; H04B 1/66; H04N 11/04; H04N 11/02

(52) U.S. Cl. 375/240.12; 375/240.18

(57) ABSTRACT

Video thumbnails for browsing video clips compressed with methods including scalable intra-frame coding are created by extraction and decoding of the base layer Intra-coded pictures of a video clip. Zoom is available by additional decoding of higher layer(s) of the intra-coded pictures. No separate video thumbnail file is required.

### BACKGROUND

The present invention relates to digital video storage, and more particularly to methods and structures for browsing stored video.

Recent years have seen an explosion in the number of video clips that are being produced and archived. This is mainly due to the increasing popularity of streaming video, camera phones, and digital camcorders. As a result, methods for easy visual browsing of stored video archives are becoming important. Video thumbnails of video clips stored in an archive can be created to aid in the process of visual browsing of the archive. That is, video thumbnails are the extension of the popular concept of image thumbnails in that video thumbnails are lower spatial and/or temporal resolution versions of the original video clip which can be easily decoded and viewed to assess the contents of the corresponding full video clip.

Known methods for video thumbnails include the Macromedia flash MX 2004 which provides a scheme to create video thumbnails. First, a user selects a set of reference frames from a given video clip, and then the user encodes the selected set of frames at a lower resolution as a separate file. Indeed, for a 10-seconds-long video clip with resolution of 240×180 pixels/frame and frame rate of 15 frames/sec, the video thumbnail could be a 2-seconds-long excerpt with resolution of 84×68 pixels/frame but the same frame rate of 15 frames/sec. Thus the video thumbnail would have a file size of roughly 3% of the original video clip file size.

Of course, both the original video clip file and the associated video thumbnail file can be compressed using a standard video coding method. Indeed, various international standards for video coding have been and are continuing to be developed. Current standards, such as H.263, MPEG-2, MPEG-4, and H.264, use a hybrid of block motion compensation and transform coding for compression. Block motion compensation decomposes a picture into blocks for prediction by blocks of preceding pictures; this relies upon removal of temporal redundancies. Transform of blocks to a spatial frequency domain (and quantization) for coding relies upon removal of spatial redundancies. In this approach there are Intra-coded pictures (I frames) and Inter-coded pictures (P and B frames). An I frame has all Intra-coded blocks which proceeds by transforming the block to the frequency domain and (quantizing and) encoding; for example, a 16×16 macroblock may have its 8×8 blocks (4 luma blocks and 2 chroma blocks) transformed with a discrete cosine transformation (DCT) or may have is 4×4 blocks (16 luma blocks and 8 chroma blocks) transformed with an integer transform which approximates a DCT. In contrast, a P or B frame has at least one Inter-coded block which proceeds by finding the best prediction block in prior pictures (thereby defining its motion vector) and then transforming the residual block (i.e., the difference block between the current block and its prediction block) to the frequency domain for (quantizing and) encoding. Note that for an I frame, a non-block transform, such as a discrete wavelet transform (DWT), could be used in place of the block transform; MPEG-4 and JPEG2000 provide for DWT.

FIG. 2 depicts the functions in typical block motion compensation video encoding using DCT and variable length coding (VLC) of the quantized transform coefficients (Q). For motion compensation (MC), inverse-quantization (IQ) and inverse DCT (IDCT) are needed for the feedback loop. Except for MC, all the functions in FIG. 2 operate on an 8×8 block basis. The rate-control unit in FIG. 2 is responsible for producing the quantizer scale (quantizer parameter, QP) according to the target bit-rate and buffer-fullness to control the DCT-coefficients quantization unit. Indeed, a larger quantizer scale implies more vanishing and/or smaller quantized coefficients which means fewer and/or shorter codewords.

However, compressing both a video clip and its associated video thumbnail has problems of maintaining two separate files and the known video thumbnails have problems including a lack of zoom capability due to the low resolution.

### SUMMARY OF THE INVENTION

The present invention provides video thumbnails which include the use of intra-coded reference frames to create video thumbnails which may be embedded in the original video clips.

### BRIEF DESCRIPTION OF THE DRAWINGS

FIGS. 1a-1b are flow diagrams.

FIG. 2 illustrates the functions of hybrid block-based motion compensation plus DCT transform video encoding.

FIGS. 3-4 show decoding.

### DESCRIPTION OF THE PREFERRED EMBODIMENTS

1. Overview

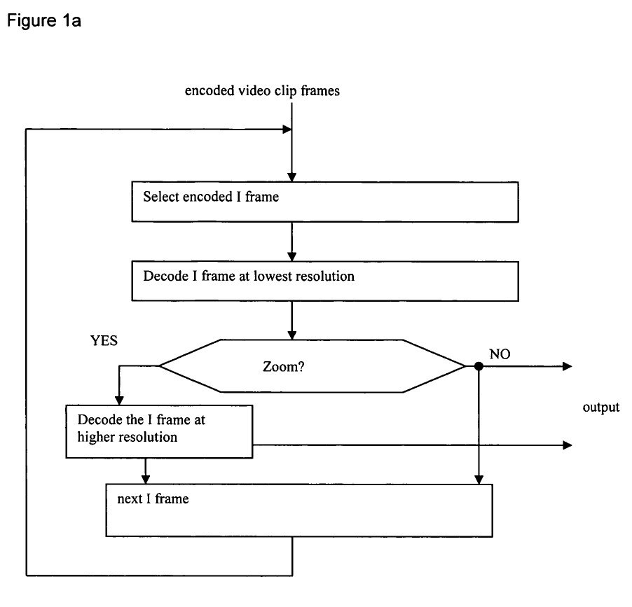

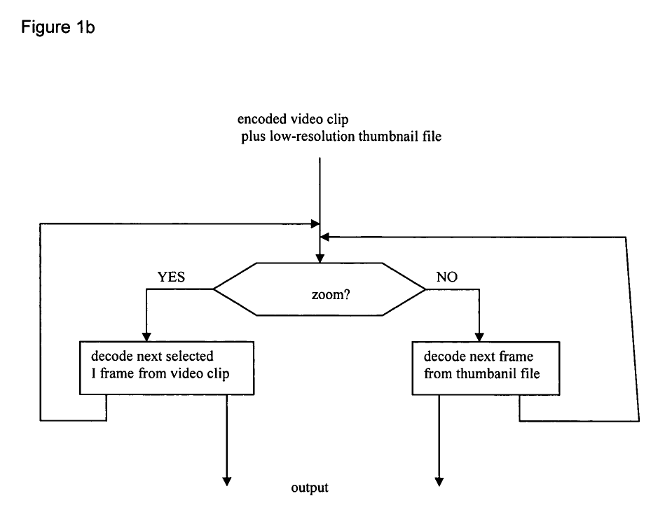

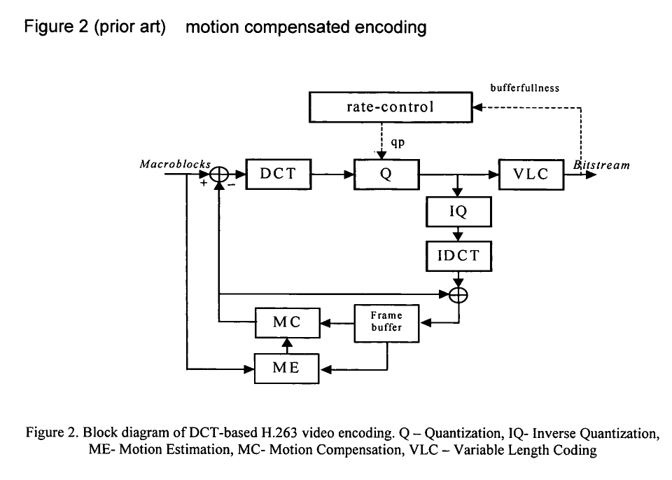

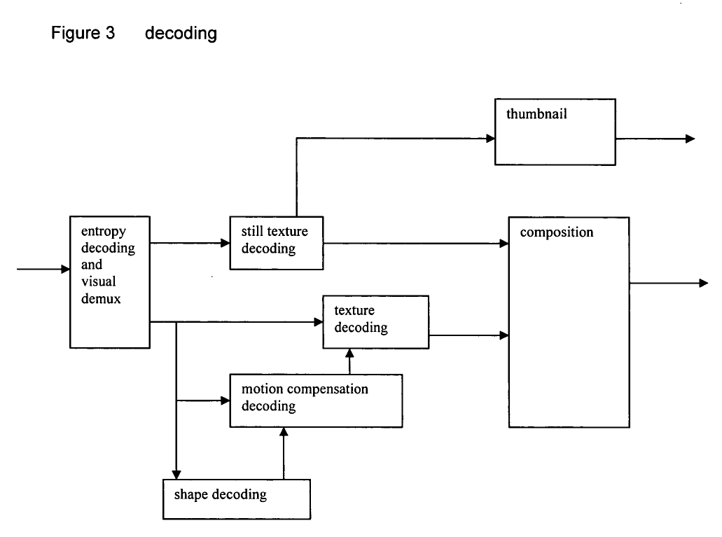

Preferred embodiment video thumbnail methods use I frames (I-vops) of an encoded video clip to extract (at least in part) a video thumbnail; and when the I frames have scalable encoding, the methods can use it for zoom. The video thumbnail may have an initial resolution determined by the low resolution of the extracted scalable encoded I frames, and the thumbnail zoom simply uses higher resolution decodings of the scalable encoded I frame. The thumbnail frame rate depends upon whether fast-forward or normal-speed motion is desired; for normal-speed motion, the video thumbnail frame rate will just be rate of available I frames. In contrast, for fast forward with a high fraction of I frames (e.g., all I frames or IPIP . . . type clips), the methods may skip I frames to approximate the target frame rate. The same approach applies to both pictures encoded as progressive frames or as interlaced fields. The preferred embodiment video thumbnail is not a separate file, but rather a method to extract a video thumbnail from the original video clip. This permits full zoom capability in the video thumbnail plus requires no additional files or storage for the video thumbnail. FIG. 1a illustrates the flow (where “next” frame may be the same frame if paused and zoomed), and FIG. 3 shows decoding for either the full video clip or for its preferred embodiment video thumbnail. FIG. 1b illustrates a preferred embodiment hybrid of extraction of thumbnail frames from intra-coded frames of a video clip for zoom together with a separate low-resolution thumbnail file. This hybrid is useful when the video clip does not have scalable intra-encoding.

Preferred embodiment systems (e.g., video clip archive with browser) perform preferred embodiment methods with digital signal processors (DSPs) or general-purpose programmable processors or application specific circuitry or systems on a chip (SoC) such as both a DSP and RISC processor on the same chip with the RISC processor controlling. Programs could be stored in memory in an onboard ROM or external flash EEPROM for a DSP or programmable processor to perform the signal processing of the preferred embodiment methods.

2. Wavelet I Frames

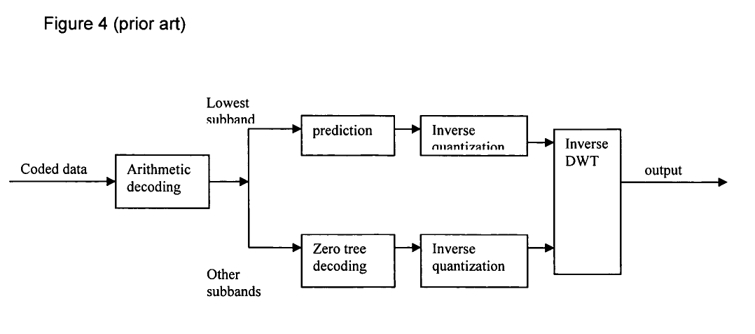

First preferred embodiment methods extract video thumbnails from video clips encoded with a zero-tree wavelet transform for I frames; this would include encoding methods such as a motion JPEG2000 (sequence of I frames) and MPEG-4 with the encoding of still texture video objects by wavelet transform plus zero-tree coding. Thus presume an encoded video clip with a frame rate of 30 frames/sec, an I frame every n frames, and I frames with zero-tree encoding of discrete wavelet transform (DWT) coefficients. In particular, presume a four-level hierarchy wavelet decomposition into subbands; that is, four repetitions of both horizontal and vertical filtering with a highpass (wavelet kernel) and the complementary lowpass (scaling function kernel) plus decimation by 2. (This is repeated half-band filtering followed by critical decimation.) Thus each 16×16 macroblock of samples roughly yields 3 8×8 blocks (the HL1, LH1, and HH1 subbands), 3 4×4 blocks (the HL2, LH2, and HH2 subbands), 3 2×2 blocks (the HL3, LH3, and HH3 subbands), and 4 1×1 blocks (the LH4, HL4, HH4, and LL4 subbands) of wavelet coefficients; that is, the 256 pixels are transformed into 256 coefficients. The LL4 coefficient is termed the DC coefficient because it is the result of four repeated lowpass filterings plus decimations. These 256 coefficients are quantized and encoded as three zero trees with the tree roots as the LH4, HL4, and HH4 coefficients plus the DC coefficient. Thus a frame of N×M macroblocks yields an N×M array of DC coefficients which is a low-resolution version of the frame plus 3 N×M zero trees. For example, the DC subband of a 640×480-pixel (VGA) I frame is a 40×30-pixel low-resolution version of the I frame. Note that this array of DC coefficients is predictively encoded in MPEG-4; see FIG. 4 illustrating decoding with the top branch for the DC coefficients.

The first preferred embodiment methods parse the video clip to select the required I frames and initially decode just the DC coefficients to give a sequence of low-resolution frames. The length and frame rate of the video thumbnail are selectable; the length is determined by where the extraction of I frames begins and ends in the video clip and the playback rate (normal-speed or fast forward).

For example, if every sixth frame is an I frame, then the video thumbnail frame rate would be 5 frames/sec for a somewhat discontinuous-appearing playback at normal speed. However, if these same I frames are used in a 25 frames/sec playback, then this would appear as a 5× fast forward.

In contrast, if the I frame rate is greater than the desired playback rate, such as for fast forward with a video clip of IPIP . . . frames, then skip I frames to achieve the desirable video thumbnail frame rate.

The first preferred embodiment video thumbnail methods provide zoom by decoding higher subbands in addition to the DC subband and combining. For example, if just the zero-tree roots are decoded, then this recovers the LH4, HL4, and HH4 subbands which, when combined with the previously-decoded DC (LL4) subband, reconstructs the LL3 subband; this is a 2N×2M array version of the original I frame. Similarly, decoding further into the zero-trees successively reconstructs 4N×4M, 8N×8M, and 16N×16M arrays with the 16N×16M being the reconstructed original I frame. In short, the preferred embodiment methods simply additionally decode sufficient higher layers of an I frame with scalable encoding to create increasing resolution zooms. Of course, upsampling plus interpolation can adjust array size and provide intermediate zoom factors.

3. DCT I Frames

Second preferred embodiment methods of video thumbnail creation are similar to the first preferred embodiments but extract from a video clip with DCT-encoded I frames. Video coding methods such MPEG-1/2/4 and MJPEG (motion JPEG) use DCT transforms for the I frames. Thus presume encoded I frames as N×M arrays of macroblocks with each macroblock a set of four 8×8 quantized luminance DCT blocks and two quantized 8×8 chrominance DCT blocks. Each 8×8 DCT block has one DC coefficient and 63 AC coefficients. The DC coefficients form a 2N×2M luminance plus two N×M chrominance arrays, and thus provide a low resolution version of the encoded I frame. For example, a 640×480-pixel encoded I frame (40×30 macroblocks) has DC coefficients forming a 80×60-pixel low resolution version of the frame.

The second preferred embodiment methods parse a video clip to select the required I frames and initially decode just the DC coefficients to give a sequence of low-resolution frames as a video thumbnail. Note that the DC coefficients may be separated from the AC coefficients by a dc marker, so the file parsing can be quite simple. Also, the DC coefficients may be encoded using predictions from earlier-in-the-scan DC coefficients, so the decoding includes inverse prediction. The length of the video thumbnail is selected by the start and stop locations in the video clip, and the frame rate of the video thumbnail is determined by the frequency of I frames in the video clip.

The second preferred embodiment video thumbnail methods provide zoom by decoding some of the AC coefficients in addition to the DC coefficients. For example, combining the three lowest frequency AC coefficients with the DC coefficient and then applying a 2×2 inverse DCT (and inverse quantization) gives a 4N×4M array version of the I frame which enhaneces the resolution of the DC-coefficient-only version.

4. H.264/AVC

Third preferred embodiment methods are similar to the first and second preferred embodiments but extract video thumbnails from an H.264/AVC encoded video clip. In particular, presume the clip includes one or more coded video sequences with each coded video sequence consisting of a series of access units that are sequential in a network access layer (NAL) unit stream and use only one sequence parameter set. Each access unit decodes to one picture. Each coded video sequence begins with an instantaneous decoding refresh (IDR) access unit which contains an Intra-coded picture, and the coded video sequence can be decoded without reference to any other coded video sequence. An access unit generally contains a set of video coding layer (VCL) NAL units which encode a picture plus various optional other NAL units such as delimiters, end of sequence, and supplemental enhancement information (SEI) non-VCL NAL units together with redundant VCL NAL units.

The third preferred embodiment methods parse a video clip to select the access units with Intra-coded pictures (including the IDR access units), and extract frames for a video thumbnail.

VCL NAL units consist of (start codes), headers, and payloads of slices or slice data partitions that represent the samples of the video picture encoded in the access unit. A picture may be partitioned into one or more slices, where a slice is a group of macroblocks (16×16 luma and 8×8 chroma) which are coded using only within-slice data plus any reference pictures. In particular, each slice can be coded using one of five coding types: (1) an “I slice” has all macroblocks encoded using intra prediction; (2) a “P slice” has at least some macroblocks coded using inter prediction with one motion-compensation prediction per block and the remaining macroblocks have I slice coding; (3) a “B slice” has at least some macroblocks coded using inter prediction with two motion-compensation predictions per block and the remaining macroblocks have P slice coding; (4) an “SP slice” is a “switching” P slice coded for efficient switching between pre-coded pictures; and (5) an “SI slice” is a switching I slice coded to provide an exact match of a macroblock in an SP slice which is useful for random access or error recovery.

All luma and chroma samples of a macroblock are either spatially (intra) predicted or temporally (inter) predicted, and the prediction residual (error) is transform coded. The spatial prediction for a luma block can be one of Intra_{—}4×4, Intra_{—}16×16, or I_PCM (which skips the prediction). The spatial prediction uses already encoded blocks (above or to the left of the current block) and is performed in the spatial domain, not the transform domain. For an Intra coded picture, the predictions are all spatial and confined to the I slice containing the current macroblock.

The transform coding utilizes 4×4 blocks and a 4×4 integer transform; the resulting coefficients consist of one DC coefficient and 15 AC coefficients. For macroblocks which had been Intra_{—}16×16 predicted in the spatial domain, the resulting 16 4×4 transformed blocks yield 16 luma DC coefficients which form a 4×4 array and which is subjected to a second 4×4 integer transform (plus 2×2 transforms for each of the corresponding two chroma DC coefficient 2×2 arrays). After transformation, scale and quantize the coefficients.

The third preferred embodiment decodes (inverse quantization, inverse scaling, inverse second integer transforms if Intra_{—}16×16) the DC coefficients to reconstruct a 4N×4M-pixel array from an Intra-encoded N×M-macroblock picture. This forms a low resolution version of the Intra encoded picture. Again with the 640×480-pixel example, the DC coefficients define a 160×120-pixel low-resolution version.

For zooming (4 to 1), include the AC coefficients of the Intra-encoded picture, and decode.

5. Hybrid Thumbnails

Alternative video clip thumbnail preferred embodiments do not rely upon scalable encoded I frames for all of the zoom capability; rather, they are hybrids with one or more separate thumbnail files of differing resolution created and stored along with the video clip to provide further zoom levels; see FIG. 1b.

In particular, a fourth preferred embodiment uses the third preferred embodiment to provide two resolutions (one-sixteenth resolution and full resolution) plus has a third resolution provided by a separate file made up of one quarter resolution versions of the same Intra-coded pictures used by the third preferred embodiment. Thus for the 640×480-pixel example, the thumbnail provides a 160×120 resolution sequence by decoding the DC coefficients of Intra pictures, a 640×480 resolution sequence by decoding entire Intra pictures, and a 320×240 resolution sequence from a separate (encoded) file of downsampled versions of the Intra pictures. This middle resolution file may have any convenient encoding to compress its size.

Further, more than one separate thumbnail file may be used to provide further resolutions in addition to those available from the I frames. For example, a preferred embodiment thumbnail for a video clip with I frames not having scalable encoding, decodes the I frames only for zoom to the highest resolution; separate thumbnail file(s) would have the lowest (initial) resolution and any intermediate resolution(s) for intermediate zoom. Again, for the 640×480-pixel example, a first separate thumbnail file provides a 160×120 resolution sequence created by downsampling the reference intra-coded pictures, (optionally) a second separate thumbnail file provides a 320×240 resolution sequence for 2 to 1 zoom and created again by downsampling reference pictures; and lastly a 640×480 resolution sequence for 4 to 1 zoom by decoding the reference pictures of the video clip. Of course, these separate thumbnail file(s) could be compressed.

6. Modifications

The preferred embodiments can be varied while retaining one or more of the features of extracting a video thumbnail from a video clip by decoding the base (low resolution) layer of Intra-coded pictures which have scalable encoding plus providing zoom by higher layer decoding and of multiple thumbnail files of varying resolution for zoom.

For example, the encoding method of the video clip could differ from the preferred embodiment examples of MPEG, H.264, . . . ; the picture/frame sizes of the video clip could vary; and so forth.

What is claimed is:

1. A method of extracting a video thumbnail, comprising:
(a) providing a video clip including a sequence of intra-coded frames and inter-coded frames; and
(b) decoding a first plurality of said intra-coded frames at a first resolution without decoding inter-coded frames.

2. The method of claim 1, further comprising:
(a) decoding a second frame of said intra-coded frames at a second resolution, wherein said second resolution differs from said first resolution and wherein said second frame may be included in said first plurality of said intra-coded frames.

3. The method of claim 1, wherein:
(a) said intra-coded frames are H.264 encoded frames; and
(b) said first resolution is a resolution of DC coefficients of intra-coded frames.

4. The method of claim 1, further comprising:
(a) providing a second sequence of frames at a second resolution, said frames of said second sequence of frames corresponding to frames of said sequence of intra-coded frames; and
(b) decoding a second frame of said second sequence of frames, wherein said second resolution differs from said first resolution.

5. A video thumbnail with zoom, comprising:
(a) a first sequence of frames of a first resolution, said first sequence of frames corresponding to frames of a video clip; and
(b) a second sequence of frames of a second resolution, said second sequence of frames corresponding to frames of said first sequence, and said second resolution differing from said first resolution.

6. The video thumbnail of claim 5, wherein:
(a) said first sequence of frames correspond to a third sequence of intra-coded frames of said video clip.

7. A method of video thumbnail with zoom, comprising:
(a) providing a video clip and a first sequence of frames wherein said first sequence of frames corresponds to a second sequence of intra-coded frames of said video clip;
(b) decoding a first plurality of said first sequence of frames at a first resolution; and
(c) when zoom is desired, decoding a second frame of said second sequence at a second resolution wherein said second resolution is greater than said first resolution.
